(19) United States
(12) Patent Application Publication
(10) Pub. No.: US 2013/0052277 A1
(43) Pub. Date: Feb. 28, 2013

(54) PROCESS FOR THE PREPARATION OF AN ANTIMICROBIAL ARTICLE

(71) Applicants: Thomas Weiss, Ilvesheim (DE); Rudolf Pfaendner, Rimbach (DE); Stefan Koch, Lampertheim (DE)

(72) Inventors: Thomas Weiss, Ilvesheim (DE); Rudolf Pfaendner, Rimbach (DE); Stefan Koch, Lampertheim (DE)

(73) Assignee: POLYMERS CRC LTD., NOTTING HILL, VICTORIA (AU)

(21) Appl. No.: 13/582,466

(22) PCT Filed: Mar. 8, 2011
(86) PCT No.: PCT/EP2011/053457

§ 371 Date: Oct. 24, 2012

(30) Foreign Application Priority Data
Mar. 9, 2010 (EP) 10155921.9
Jun. 18, 2010 (EP) 10166458.9

(51) Int. Cl. A01N 59/16; A01P 1/00

(52) U.S. Cl. 424/618

(57) ABSTRACT

Disclosed is a process for preparing an antimicrobial article, wherein a silver colloid is formed in situ as a result of the components employed. The process comprises the steps of (i) providing a liquid, which contains a soluble polar polymer in a solvent selected from certain polar organic solvents; (ii) adding a silver salt selected from alpha-functionalized silver carboxylates to said liquid; (iii) allowing the mixture to react with formation of a silver colloid; and (iv) separating the solvent from the mixture and forming of the antimicrobial article. The antimicrobial articles thus obtained may be sheets, films, fibres, coating layers, and especially membranes like a semipermeable membrane for ultrafiltration, water separation or gas separation.

The instant invention relates to a specific process for the preparation of an antimicrobial article such as a polymer membrane. The antimicrobial article exhibits controlled biocidal effectiveness while maintaining good further use properties. The process allows to tailor the antimicrobial properties of the article.

Imparting antimicrobial properties to polymer articles and surfaces thereof is important wherever humid conditions are applied or sterility of the surface is required. Silver has been used in this field as an antimicrobial agent for more than a century, but its effects have often been shown to disappear after short times of usage. This undesired effect may be due to leaching, especially when soluble forms of ionic silver have been employed, or due to tight encapsulation of the silver inventory. Since the oligodynamic effect of silver may already be observed at concentrations of mobile silver species, which are much lower than those typically provided by silver salts of high solubility, particles have been incorporated into the articles which contain a reservoir releasing silver slowly and over an extended period of time. These particles usually contain, or consist of, metallic silver or ionic silver of low solubility.

To prevent leaching while retaining good activity, the particles need to be embedded in a polymer matrix in highly dispersed form, often in the form of nanoparticles or silver clusters of typical particle diameters 5-100 nm, still providing a certain mobility of silver species. Agglomeration of pre-fabricated particles of sub-micron size may be avoided by in-situ formation in an environment transferable into the final polymer matrix; WO 09/056401 describes silver reduction with ascorbic acid, followed by addition of acrylic monomers, polymer dispersants and removal of water under vacuum. WO09/027396 describes the reduction of certain silver carboxylates in presence of a polymer like PVP serving as nucleation aid and using ascorbic acid as a reducing agent, to obtain a silver nanoparticle dispersion in the polymer after centrifugation. To avoid unwanted effects by addition of a separate component, JP-A-2004-307900 proposes the combination with a polymer or solvent functioning as a reducing agent.

The problems of biofouling and leaching of biocidal or biostatic agents are pronounced in semipermeable membranes used for separation purposes like ultrafiltration or reverse osmosis. U.S. Pat. No. 5,102,547 proposes various methods for the incorporation of of oligodynamic materials including silver powders and silver colloids into membranes. U.S. Pat. No. 6,652,751 compares several bacteriostatic membranes obtained after contacting polymer solutions containing a metal salt with a coagulation bath containing a reducing agent. In situ formation of a colloid by reducing silver nitrate with DMF for membrane preparation is taught by EP-A-2160946.

It has now been found that colloidal silver may be efficiently incorporated into a matrix containing pore-forming polymers by in-situ reduction of specific silver salts. The method of the invention allows formation of the metal colloid under mild conditions without further addition of a reducing agent or application of high energy radiation or high temperatures.

### SUMMARY OF THE INVENTION

Present invention thus primarily pertains to a process for preparing an antimicrobial article comprising the steps of

(i) providing a liquid, which contains a soluble polar polymer in a solvent comprising a polar organic solvent selected from keto compounds;

(ii) adding a silver salt selected from alpha-functionalized silver carboxylates to said liquid;

(iii) allowing the mixture to react with formation of a silver colloid; and

(iv) separating the solvent from the mixture and forming of the antimicrobial article.

The polymeric article (i.e. antimicrobial article) of the invention is preferably an article having a large surface/volume ratio such as a sheet, film, (coating) layer, woven or nonwoven, or especially a membrane such as a semipermeable membrane, e.g. for ultrafiltration purposes, water separation or gas separation.

Conventional processes for the preparation of silver metal particles use various methods for the reduction of metal salts such as thermal, radiation, ultrasonic, electrochemical or microwave techniques, and especially addition of chemical reducing agents. For example, a metal salt is reacted with a reducing agent to form the metal particles; reducing agents often employed include formaldehyde, dimethylformamide (DMF), sodium borohydride (NaBH₄) and hydrazine. An advantage of the present process is that no such additional reducing agent is required for the formation of the present silver nanoparticles; instead, reduction of the silver salt and formation of silver nanoparticles is effected in situ by the present reagents and combination of steps. If pore forming polymers are used, the present process yields materials and articles containing silver particles trapped within pores, thus providing high silver mobility combined with low leaching characteristics.

### PREFERRED EMBODIMENTS OF THE INVENTION

Steps (i), (ii) and (iii) are usually carried out in immediate sequence. The addition of silver salt in step (ii) is advantageously carried out with thorough mixing. The silver salt is preferably added as such, i.e. as a solid salt, a suitable dispersion or solution, without additional salt components; preferred is the addition as solid salt or dispersion.

Step (i): The liquid may be a solution or dispersion, it may contain one or more polymeric components. The soluble polar polymer is generally selected from pore forming polymers (such as poly-N-vinylpyrrolidone (PVP), PVP copolymers with vinyl acetate, polyethylenglycole (PEG), sulfonated poyl(ether)sulfone (sPES)) and/or matrix forming polymers (such as polysulfones, polyethersulfones, polyvinylidene fluorides, polyamides, polyimides, cellulose acetate, vinyl acetate, polyvinyl alcohols, polymeric carbohydrates, soluble proteins such as gelatin) and copolymers and mixtures thereof.

The soluble polar polymer may be from a wide range of molecular weights, e.g. ranging from 1500 to about 2500000. Antimicrobial polymer membranes of the invention may also be based on alkoxyamine fuctionalized polysulfones or polysulfone-graft-copolymers, e.g polysulfone-graft-poly-4-vinylbenzylchloride copolymer, as the soluble polar polymer, as described in WO09/098161.

The polar organic solvent is often selected from keto compounds such as esters, amides, lactones, lactames, carbonates, sulfoxides, preferably from solvents typically used for membrane manufacturing like N-methylpyrrolidone (NMP), dimethylacetamide (DMAc), dimethylsulfoxide (DMSO), other cyclic lactames, lactones like gammabutyrolacton, carbonates, or mixtures thereof. The solvent may also contain water as a minor component, a preferred solvent consisting essentially of said polar organic solvent, or mixtures thereof, and water. “Consisting essentially of” in this context means that the component thus denoted forms the major part by weight of the solvent, i.e. at least 50% by weight, preferably at least 70% by weight, especially at least 90% by weight. The ratio of polymer to solvent is preferably chosen to obtain a viscous solution or dispersion, e.g. ratio of polymer to solvent ranging from 1:30 to 1:1. The temperature of the mixture is generally not critical and may be chosen, for example, from the range 5-250° C.; preferably, the mixture is heated until a viscous solution is obtained, typically to temperatures 25-150° C., preferably 40-100° C., most preferably to 60-90° C. Heating may be effected after the addition step (ii) or, preferably, before step (ii).

Step (ii): The silver salt (i.e. silver educt), which is an alpha-functionalized silver carboxylate, is often selected from silver-lactate, silver-citrate, silver-tartrate, silver benzoate, silver-acrylate, silver-methacrylate, silver-oxalate, silver-trifluoroacetate or mixtures thereof, preferred is silver-lactate, silver-citrate, silver-tartrate, most preferred is silver-lactate. The silver salt may be added as a solid, preferably in the form of a powder or suspension, or as a solution. Suspensions or solutions are preferably in a solvent or solvent mixture as described in step (i). Advantageously, addition to the mixture from step (i) is done with mixing, e.g. stirring and/or sonication, and preferably to the mixture heated as described. The amount of silver educt added is often chosen to obtain a final Ag-concentration (after step (ii) and after an optional further addition of polymer as described below) of 1-100000 ppm, preferably 100-10000 ppm, most preferably 1000-6000 ppm, each relative to the total amount of polymer present in step (iv).

Step (iii): Besides the components mentioned in steps (i) and (ii) and optional further steps mentioned, no further components (such as reducing agents) are added in general. Metal colloid formation usually is completed within 0.5 to about 20 h; preferred reaction time is chosen from the range 1-15 h, typically 1-4 h. Before carrying out step (iv), the mixture is advantageously degassed.

Step (iv): The antimicrobial article is often formed using a casting or coating process. The solvent may be removed, for example, by phase separation (such as a coagulation bath, typically used for the preparation of membranes), or by a conventional drying process (e.g. under reduced pressure).

These process steps are usually carried out subsequently, i.e. first step (i), then step (ii), then step (iii), then step (iv).

Optional further steps: After step (ii) and/or after step (iii), and before step (iv), one or more further polymers of the classes described for step (i) may be added as such or in form of a solution or dispersion in a solvent as described for step (i). In a preferred embodiment, step (i) uses a pore forming polymer (such as PVP), and a matrix forming polymer (such as described for step (i); e.g. polyethersulfone) is added after step (ii). Step (iv) may be followed by a step reconverting metallic silver to a ionic, preferably non-leaching form, e.g. a conventional hypochlorite treatment converting metallic silver into silver chloride.

Further additives may also be present in the polymer articles or membranes (e.g. after adding these components to the polymer dope, preferably between steps (iii) and (iv), or by surface treatment or coating of the final article. Such additives include antimicrobials, for instance di- or trihalogeno-hydroxydiphenylethers such as Diclosan or Triclosan, 3,5-dimethyl-tetrahydro-1,3,5-2H-thiodiazin-2-thione, bis-tributyltinoxide, 4.5-dichlor-2-n-octyl-4-isothiazolin-3-one, N-butyl-benzisothiazoline, 10.10′-oxybisphenoxyarsine, zinc-2-pyridinthiol-1-oxide, 2-methylthio-4-cyclopropylamino-6-(α,β-dimethylpropylamino)-s-triazine, 2-methylthio-4-cyclopropylamino-6-tert-butylamino-s-triazine, 2-methylthio-4-ethylamino-6-(α,β-dimethylpropylamino)-s-triazine, 2,4,4′-trichloro-2′-hydroxydiphenyl ether, IPBC, carbendazim or thiabendazole. Further additives useful may be selected from the materials listed below, or mixtures thereof:

1. Antioxidants:

1.1. Alkylated monophenols, for example 2,6-di-tert-butyl-4-methylphenol,

1.2. Alkylthiomethylphenols, for example 2,4-dioctylthiomethyl-6-tert-butylphenol,

1.3. Hydroquinones and alkylated hydroquinones, for example 2,6-di-tert-butyl-4-methoxyphenol, 2,5-di-tert-butylhydroquinone,

1.4. Tocopherols, for example α-tocopherol,

1.5. Hydroxylated thiodiphenyl ethers, for example 2,2′-thiobis(6-tert-butyl-4-methylphenol),

1.6. Alkylidenebisphenols, for example 2,2′-methylenebis(6-tert-butyl-4-methylphenol),

1.7. O-, N- and S-benzyl compounds, for example 3,5,3′,5′-tetra-tert-butyl-4,4′-dihydroxydibenzyl ether,

1.8. Hydroxybenzylated malonates, for example dioctadecyl-2,2-bis(3,5-di-tert-butyl-2-hydroxybenzyl)malonate,

1.9. Aromatic hydroxybenzyl compounds, for example 1,3,5-tris(3,5-di-tert-butyl-4-hydroxybenzyl)-2,4,6-trimethylbenzene,

1.10. Triazine compounds, for example 2,4-bis(octylmercapto)-6-(3,5-di-tert-butyl-4-hydroxyanilino)-1,3,5-triazine,

1.11. Benzylphosphonates, for example dimethyl-2,5-di-tert-butyl-4-hydroxybenzylphosphonate,

1.12. Acylaminophenols, for example 4-hydroxylauranilide,

1.13. Esters of β-(3,5-di-tert-butyl-4-hydroxyphenyl)propionic acid with mono- or polyhydric alcohols,

1.14. Esters of β-(5-tert-butyl-4-hydroxy-3-methylphenyl)propionic acid with mono- or polyhydric alcohols,

1.15. Esters of β-(3,5-dicyclohexyl-4-hydroxyphenyl)propionic acid with mono- or polyhydric alcohols,

1.16. Esters of 3,5-di-tert-butyl-4-hydroxyphenyl acetic acid with mono- or polyhydric alcohols,

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide,

1.18. Ascorbic acid (vitamin C),

1.19. Aminic antioxidants, for example N,N′-di-isopropyl-p-phenylenediamine.

2. UV absorbers and light stabilizers:

2.1. 2-(2′-Hydroxyphenyl)benzotriazoles, for example 2-(2′-hydroxy-5′-methylphenyl)-benzotriazole,

2.2. 2-Hydroxybenzophenones, for example the 4-hydroxy derivatives,

2.3. Esters of substituted and unsubstituted benzoic acids, for example 4-tert-butyl-phenyl salicylate,

2.4. Acrylates, for example ethyl α-cyano-β,β-diphenylacrylate,

2.5. Nickel compounds, for example nickel complexes of 2,2′-thio-bis[4-(1,1,3,3-tetramethylbutyl)phenol],

2.6. Sterically hindered amines, for example bis(2,2,6,6-tetramethyl-4-piperidyl)sebacate.

2.7. Oxamides, for example 4,4′-dioctyloxyoxanilide,

2.8. 2-(2-Hydroxyphenyl)-1,3,5-triazines, for example 2,4-bis(2,4-dimethylphenyl)-6(2-hydroxy-4-octyloxyphenyl [or-4-dodecyl/tridecyloxyphenyl])-1,3,5-triazine.

3. Metal deactivators, for example N,N′-diphenyloxamide.

4. Phosphites and phosphonites, for example triphenyl phosphite.

5. Hydroxylamines, for example N,N-dibenzylhydroxylamine.

6. Nitrones, for example, N-benzyl-alpha-phenylnitrone.

7. Thiosynergists, for example dilauryl thiodipropionate.

8. Peroxide scavengers, for example esters of β-thiodipropionic acid.

10. Basic co-stabilizers, for example melamine.

11. Nucleating agents, for example inorganic substances, such as talcum, metal oxides.

12. Fillers and reinforcing agents, for example calcium carbonate, silicates.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384.

For more details on stabilizers and additives useful, see also list on pages 55-65 of WO 04/106311, which is hereby incorporated by reference.

The following examples illustrate the invention; unless otherwise stated, room temperature denotes an ambient temperature of 20-25° C.

Abbreviations used in the examples and elsewhere:

NMP N-methylpyrolidone

PES Poylethersulfone

PVP Polyvinylpyrolidone

SEM Scanning Electron Microscopy

Silver salt educts (all from Aldrich, Germany) used are

AgOAc: Silver acetate (CH₃COOAg)

AgLac: Silver lactate (CH₃CH(OH)COOAg)

AgCit: Silver citrate (Citric acid trisilver salt hydrate)

AgBen: Silver benzoate hydrate (C₆H₅COOAg×H₂O)

AgTos: Silver p-toluenesulfonate (CH3C6H4SO3Ag)

### EXAMPLE 1

### Preparation of Silver Colloid in Presence of Polymer

Instruments used are 250 mL Erlemeyer glass tubes, magnetic stirrer, heat plate.

4 g of polyvinylpyrrolidone (Luvitec K40) are dissolved in 40 ml of NMP at 60° C. or 90° C. as indicated in table 1. At constant temperature, the silver salt identified in table 1 is added to the PVP-NMP solution as a solid, and the reaction mixture is stirred for 2 h. The colloidal dispersion obtained is directly employed as the silver additive in the below example 2.

Analysis: Particle size distribution and specific surface is detected using laser diffraction (Mastersizer® 2000 [Malvern]; see also: http://www.fritsch-laser.de/uploads/media/GIT_analysette_{—}22.pdf; dispersion fluid: N-methylpyrrolidone). The content of colloidal silver and ionic silver in the mixture thus obtained is determined by titration: 0.1 m HCl (purchased from Aldrich) is used as titrant; an ion-selective electrode in respect to Ag/AgCl-(KCl 1 M) is used as a reference for indication of the equivalent point. Each sample is split up in two parts: One part is digested with excess of nitric acid to transfer all silver into ionic form; the second part is directly titrated without nitric acid treatment. The difference of the detected silver concentration represents the amount of colloidal Ag(0) in the organic solution. Results are compiled in the following table 1.

TABLE 1
Colloid formation in presence of PVP

| sample | | amount | init. conc | temp. | % of Ag as | surface |
|---|---|---|---|---|---|---|
| No. | salt | (g) | (ppm) | (° C.) | colloid | (m²/g) |
| 2* | AgOAc | 0.136 | 2000 | 60 | 0 | |
| 3 | AgLac | 0.161 | 2000 | 60 | 89 | 73.1 |
| 4 | AgCit | 0.139 | 2000 | 60 | 43 | |
| 5 | AgBen | 0.187 | 2000 | 60 | 38 | |
| 6* | AgTos | 0.228 | 2000 | 60 | 0 | |
| 7* | AgOAc | 0.272 | 4000 | 60 | 0 | |
| 8 | AgLac | 0.321 | 4000 | 60 | 94 | 22.4 |
| 9 | AgCit | 0.279 | 4000 | 60 | 23 | |
| 10 | AgBen | 0.374 | 4000 | 60 | 20 | |
| 11* | AgTos | 0.455 | 4000 | 60 | 0 | |
| 12* | AgOAc | 0.136 | 2000 | 90 | 2 | |
| 13 | AgLac | 0.161 | 2000 | 90 | 91 | 22.3 |
| 14 | AgCit | 0.139 | 2000 | 90 | 28 | |
| 15 | AgBen | 0.187 | 2000 | 90 | 16 | |
| 16* | AgTos | 0.228 | 2000 | 90 | 1 | |
| 17* | AgOAc | 0.272 | 4000 | 90 | 34 | |
| 18 | AgLac | 0.321 | 4000 | 90 | 93 | 21.5 |
| 19 | AgCit | 0.279 | 4000 | 90 | 43 | |
| 20 | AgBen | 0.374 | 4000 | 90 | 11 | |
| 21* | AgTos | 0.455 | 4000 | 90 | 1 | |

*Samples marked with an asterisks are comparisons, others show silver educts to be used according to the invention.

The example shows that silver salts of functionalized carboxylic acids like citrates, benzoates and especially lactates reliably form colloidal dispersions in presence of the polymer solution.

### EXAMPLE 2

### Membrane Preparation

70 ml of N-methylpyrolidone (NMP) are placed in a three-neck flask with agitator. Polyvinylpyrolidone (Luvitec® PVP 40 K; 6.0 g) is added, the mixture is heated to 60° C. and stirred until a homogeneous clear solution is obtained. The amount of silver educt required to reach the concentration shown in the below table 2 is added to 6 g of NMP and sonicated for 20 minutes; the suspension obtained is then added to the PVP solution and stirred until homogeneous. Polyethersulfone Ultrason® 2020 PSR (18 g) is added and stirring is continued until a viscous homogenous solution is obtained. The solution is degassed overnight at without heating (temperature of the mixture: 20-40° C.). After reheating to 70° C., a membrane is cast on a glass plate with a casting knife (wet thickness 200 μm) at room temperature and allowed to dry for 30 seconds before immersion in a water coagulation bath of 25° C. After 10 minutes of immersion, the membrane obtained is rinsed with hot water (65-75° C., 30 minutes). The bright yellow coloured membrane indicates the incorporation of elemental sub-micron silver particles.

Some of the membranes are objected to NaOCl treatment: The membrane is prepared as described above; however, the membrane is first immersed in a coagulation bath containing 4000 ppm of NaOCl (pH 11.5, 25° C.) for 60-90 s, then in the pure water bath for 10 min. The bright white colour of the membranes thus obtained indicates the formation of silver chloride.

The membranes are stored in water (250 mL) for 2 weeks at 25° C. After drying at room temperature, the samples are dried for 15 h at 50° C. under vacuum (1-10 mbar).

Membranes are obtained as a continuous film (at least 10×15 cm size) with a top thin skin layer (1-2 microns) and a porous layer underneath (thickness: 100-150 microns), further characterized by: Void breadth on top 2.0 μm; skin layer 1.2 μm; thickness 120 μm; pore size under skin layer 1-3 μm (determined by cross section SEM analysis).

Analysis: Digestion of 30-40 mg of the membrane sample in 1 ml 65% HNO3 (65%) in a sealed glass tube; heating for 6 h at 270° C. until a transparent solution is obtained. The method for silver analysis: ICP—MS (Inductively Coupled Plasma—Mass Spectrometry). Results are compiled in the following table 2.

TABLE 2
Characterization of membranes

| Membrane | | amount | | Ag conc. | Ag in membrane |
|---|---|---|---|---|---|
| No. | Ag educt | (g) | NaOCl | (ppm) | (ppm) |
| 0 (comp.) | — | 0 | — | 0 | 0 |
| M1 | AgBen | 0.076 | — | 2000 | 31.5 |
| M2 | AgLac | 0.066 | — | 2000 | 560.5 |
| M3 | AgLac | 0.132 | — | 4000 | 2000 |
| M4 | AgBen | 0.076 | yes | 2000 | |
| M5 | AgLac | 0.066 | yes | 2000 | |

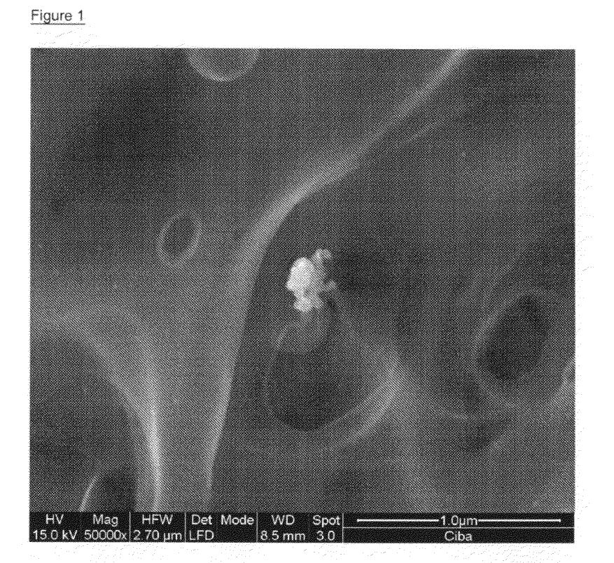

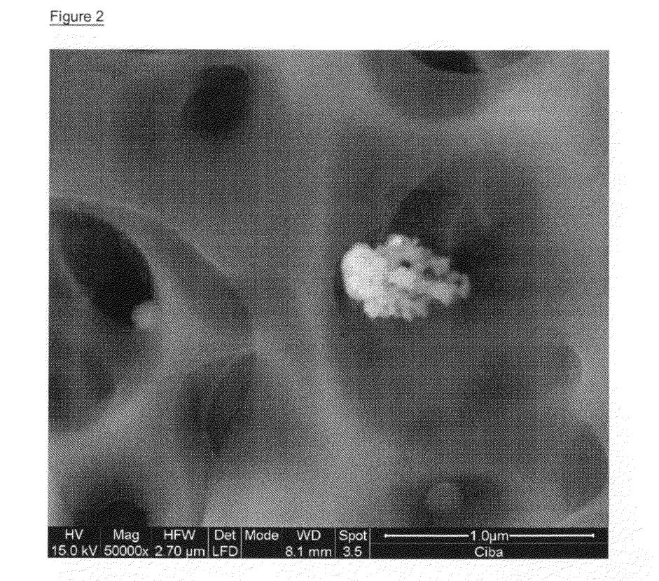

Certain samples are further investigated using scanning electron microscioy (SEM/EDX); FIGS. 1 and 2 show results for Membranes M3 and M5.

### EXAMPLE 3

### Antimicrobial Performance of the Membrane

Testing is conducted against Escherichia coli and Staphylococcus aureus according to ASTM 2149. This test measures the antimicrobial activity of test samples by shaking aliquots of polymer film (cut into small pieces prior to testing) in a bacterial suspension with a bacteria concentration of ˜10⁵ colony forming units (cfu) per ml in a total volume of 25 ml. Investigation of E. coli is conducted as double determination of aliquots of polymer film in 12.5 ml. The total contact time is 24 hours. The suspension is serially diluted before and after contact and cultured. The number of viable organisms in the suspension is determined and the percent reduction calculated based on initial counts or on retrievals from appropriate untreated controls. Results are compiled in the below table 3.
Test strains: Escherichia coli (Ec) DSM 682 (ATCC 10536)
   Staphylococcus aureus (Sa) DSM 799 (ATCC 6538)

Test conditions/Sample parameters:
age of Kryo-culture Ec: 11d
   Sa: 15d
Dilution of inoculum Sa: 1:40
   Ec: 1:100
test medium phosphate buffer (KH2PO4)
shaking mode reciprocal shaking
exposure temperature room temperature
exposure time 24 hrs
superwetting agent
(0.01% Dow Corning) yes
Diluent for plating phosphate buffer (KH2PO4)
sample amount 30 cm2/25 ml
sample preparation 4 pieces à˜7.5 cm²

TABLE 3
Colony forming units (cfu) per ml found

| Membrane No. | Ag educt | exposure | E. coli | S. aureus |
|---|---|---|---|---|
| none (control) | — | 0 h | 3.7E+05 | 3.7E+05 |
| none (control) | — | 24 h | 8.7E+05 | 5.5E+05 |
| 0 (comp.) | — | 0 h | 5.8E+05 | 3.5E+05 |
| 0 (comp.) | — | 24 h | 3.1E+05 | 7.0E+05 |
| 0 (comp.) | — | 24 h | 5.0E+05 | 7.2E+05 |
| M1 | AgBen | 24 h | 120 | 120 |
| M1 | AgBen | 24 h | 6400 | 240 |
| M2 | AgLac | 24 h | <1 | <1 |
| M3 | AgLac | 24 h | <1 | <1 |
| M4 | AgBen | 24 h | <1 | <1 |
| M5 | AgLac | 24 h | <1 | 26 |
| M5 | AgLac | 24 h | <1 | <1 |

The present membranes show good activity against E. coli and S. aureus.

1. A process for preparing an antimicrobial article comprising the steps
(i) providing a liquid, which contains a soluble polar polymer in a solvent comprising a polar organic solvent selected from esters, amides, lactones, lactames, carbonates, sulfoxides, and mixtures thereof;
(ii) adding a silver salt selected from silver-lactate, silver-citrate, silver-tartrate, silver benzoate, silver-acrylate, silver-methacrylate, silver-oxalate, silver-trifluoroacetate, and mixtures thereof, to said liquid;
(iii) allowing the mixture to react with formation of a silver colloid; and
(iv) separating the solvent from the mixture and forming of the antimicrobial article.

2. Process of claim 1, wherein the antimicrobial article is a sheet, film, fibre, coating layer, or a membrane.

3. Process of claim 1, wherein the soluble polar polymer is selected from polyvinylpyrrolidone, polyvinylpyrrolidone copolymers with vinyl acetate, polyethylenglycole, sulfonated poyl(ether)sulfone, polysulfones, polyethersulfones, polyvinylidene fluorides, polyamides, polyimides, cellulose acetate, vinyl acetate, polyvinyl alcohols, polymeric carbohydrates, soluble proteins, alkoxyamine fuctionalized polysulfones, polysulfone-graft-copolymers, copolymers thereof and mixtures thereof.

4. Process according to claim 1, wherein the solvent essentially consists of said polar organic solvents or mixtures thereof, or mixtures of one or more of said solvents with a minor amount of water.

5. Process according to claim 1, wherein the silver salt is selected from silver-lactate, silver-citrate, and silver-tartrate.

6. Process according to claim 1, wherein the silver salt is added in step (ii) as a solid in the form of a powder or suspension, or as a solution.

7. Process according to claim 1, wherein the amount of silver added is chosen to obtain a final silver concentration, relative to the total amount of polymer present in step (iv), of 1-100000 ppm.

8. Process according to claim 1, wherein, besides the polymer, the organic solvent and the silver salt, no compound capable of reducing ionic silver to metallic silver is added, and no high energy irradiation capable of reducing ionic silver to metallic silver is applied, before carrying out step (iii).

9. Process according to claim 1, wherein the antimicrobial article is formed in step (iv) by a casting or coating process.

10. Process according to claim 1, wherein after step (ii) and/or after step (iii), and before step (iv), one or more further polymers of the classes described for step (i) are added as such or in form of a solution or dispersion in a solvent as described for step (i).

11. Process according claim 1, wherein a solution of polyvinylpyrrolidone and/or polyvinylpyrrolidone copolymers with vinyl acetate is provided in step (i), subsequently the silver salt is added (step ii), and subsequently a sulfonated polysulfone, sulfonated polyethersulfone, polysulfone and/or polyethersulfone is added; or wherein a solution of a sulfonated polysulfone, sulfonated polyethersulfone, polysulfone and/or polyethersulfone is provided in step (i), subsequently the silver salt is added (step ii), and subsequently polyvinylpyrrolidone and/or polyvinylpyrrolidone copolymers with vinyl acetate is added.

12. Process according to claim 1, wherein a further step (v) is carried out by converting the silver particles into those of a silver halide of low solubility, by treatment with a suitable oxidizing halogen compound.

13. Semipermeable membrane obtained according to the processes of claim 1.

14. Process according to claim 4 wherein the polar organic solvent is selected from N-methylpyrrolidone, dimethylacetamide, dimethylsulfoxide, other cyclic lactames, lactones, and carbonates.

15. Process according to claim 12 where the oxidizing halogen compound is NaOCl.
